(19) United States
(12) Patent Application Publication
(10) Pub. No.: US 2026/0128027 A1
(43) Pub. Date: May 7, 2026

(54) PREFORMED FACEPIECE CUSHION FOR AN ACOUSTIC MASK AND COMBINATION THEREOF

(71) Applicant: TALK SYSTEMS INC, Victoria (CA)

(72) Inventor: Damon WEBB, Victoria (CA)

(73) Assignee: TALK SYSTEMS INC, Victoria (CA)

(21) Appl. No.: 18/936,656

(22) Filed: Nov. 4, 2024

(51) Int. Cl. G10K 11/168; B32B 1/00; B32B 5/18

(52) U.S. Cl. CPC G10K 11/168; B32B 1/00; B32B 5/18; B32B 2250/02; B32B 2307/102; B32B 2307/536; B32B 2307/718

(57) ABSTRACT

An acoustic mask, the acoustic mask comprising: an outer housing which terminates in an outer rim; and a preformed facepiece cushion, which is directly or indirectly mounted on the outer housing, the preformed facepiece cushion comprising a preformed, soft cushion pad and a flexible lip which is attached to the preformed, soft cushion pad.

### FIELD

The present technology is a facepiece cushion that is preformed to fit over a user's mouth, under the nose and above the chin. It is also an acoustic mask that includes the preformed facepiece cushion.

### BACKGROUND

Various devices have been developed for damping and recording voice sound waves. For example, U.S. Pat. No. 3,114,802 discloses an early design that essentially provides a cup-like structure for fitting over the user's mouth, with a microphone housed therein.

Similar devices have been used by court reporters. One such acoustic mask is disclosed in U.S. Pat. No. 3,193,624. This device has a cylindrical outer casing and a separate wall structure housed within the casing with a microphone mounted on this structure. The device includes a cylindrical air inhalation passageway extending outward from the face-masking structure for inhalation, with a diaphragm to restrict expulsion of air. One or more openings in the face-masking structure allow for exhaled air and sound to escape. The face-fitting part of the device is rubber and must be pressed to the user's face in order to reduce the amount of sound escaping to the ambient. It is stretched over the mask wall. It is not preformed to fit to a user's face.

Another acoustic mask is disclosed in U.S. Pat. No. 4,129,754. The device includes a barrel with a bell-shaped back, the latter preferably being set at an angle with respect to the barrel. A microphone is positioned at the end of the barrel remote from the bell-shaped back. The barrel portion and a portion of the bell-shaped back are lined with foam urethane to muffle noise and absorb moisture. The reporting device includes orifices located at the junction between the bell-shaped back (face piece) and the barrel for permitting pressurized air within the device to escape to the outside via an air communication channel from inside the device to the outside. The face piece is made of rubber or other deformable material that requires it be pressed against the user's face in order to reduce escape of the user's voice from within the device. It varies in hardness and rigidity from being soft and deformable in the area that comes in contact with the user's face to being relatively hard and rigid in the area which is in contact with the top portion of the device. It is not preformed to fit the user's face.

U.S. Pat. No. 8,243,944 discloses a handheld foldable voice-muffling device using passive noise damping materials to decrease noise and a single microphonic transceiver to transmit a user's speech and receive incoming signals allowing him to wirelessly communicate with another person or other communication devices. The deformable materials used in the device do not adequately muffle the sound of the user nor ambient sound. Further, the device must be pressed to the user's face in order for the deformable material to form to the user's face. It is not preformed to fit a use's face. This is uncomfortable for the user, but is necessary to reduce the escape of sound between the face piece and the user's face.

U.S. Pat. No. 9,912,819 discloses a device for simultaneously communicating with a first wireless communication device and a second wireless communication device. A microphone is housed within the device and circuitry therefor is included in the device, and preferably housed within the device. The device form-fits generally over a user's mouth and nose and has an air tube extending substantially the length of the device, within the interior of the device, to relieve back-pressure. The device is shaped to promote attenuation of sound within the device, and is constructed to reduce uptake of outside, extraneous sound by the microphone. The circuitry comprises one or more processors, an audio capture module, power management module, listening output module, and data storage module. The device also has a touch screen interface. There is no padding on the device so it is not comfortable to wear.

U.S. Pat. No. 11,223,887 discloses an audio capture and transmission device for simultaneously communicating with a wireless communication device and a wired communication device is provided, the audio capture and transmission device for fitting generally over a user's mouth, the audio capture and transmission device comprising: an inner housing, the inner housing including a distal end, an air tube extending inward and outward therefrom, a proximal end and walls therebetween to define a cavity and a gutter on an outer surface; a gasket seated in the gutter; a form-fitting face piece located proximally on the inner housing, the form-fitting face piece defining a proximal opening continuous with the cavity; an outer housing, the outer housing, the gasket and the inner housing defining an interior, the outer housing including a distal end, the distal end including a plurality of apertures and an exhaust port, the exhaust port aligned with the air tube and in gaseous communication with the air tube; a microphone which is housed within the cavity; and electronics which are housed in the interior and include a wireless radio, a headphone jack and circuitry. The face piece includes a resilient plastic polymer oval ring which has a resilient lip that fits into the outer rim and a soft cushioned pad for form-fitting over a user's mouth. It is not pre-formed to fit the user's face.

U.S. Pat. No. D868,723 discloses a voice mask with a facepiece that is essentially a doughnut shape until mounted onto a sleeve. The facepiece is of consistent depth. Once mounted on the sleeve, it takes on the curve of the end of the sleeve. In use, the facepiece obstructs the user's nose.

What is needed is a face piece that is preformed to conform to the user's face. It would be preferable if it could be used on a number of different acoustic mask designs. It would be preferable if it could also be used on an insert that is inserted into the body of the acoustic mask. It would be preferable if it was preformed in a form that did not interfere with the user's nose or chin. It would be still further preferable if it was of a consistent durometer throughout.

### SUMMARY

The present technology is a face piece that is preformed to conform to the user's face. It can be used on a number of different acoustic mask designs. It can also be used on an insert that is inserted into the body of the acoustic mask. It is preformed in a form that does not interfere with the user's nose or chin. It is of a consistent durometer throughout.

In one embodiment, a preformed facepiece cushion is provided for use with an acoustic mask, the preformed facepiece cushion comprising:
a preformed, soft cushion pad which includes: a proximal end; a distal end; a covering; an interior, which is filled with an upper gel layer and a lower foam layer; a top at the proximal end; a bottom at the proximal end; a pair of sides that extend between the top and the bottom; and a length that is continuous with the pair of sides and extends between the top and the bottom; a top depression which curves downward distally from each side along the length on the top; and a bottom depression which curves downward distally from each side along the length on the bottom;
and a flexible lip which is attached to the covering at the distal end of the preformed, soft cushion pad.

In the preformed facepiece cushion, the lower foam layer of the preformed, soft cushion pad may have a durometer ranking of 45 to 55 on the Shore OO durometer scale.

In the preformed facepiece cushion, the upper gel layer of the preformed, soft cushion pad may weigh 22 grams.

In the preformed facepiece cushion, the top depression and the bottom depression in the preformed, soft cushion pad may be 10 millimeters deep.

In another embodiment, an acoustic mask is provided, the acoustic mask comprising: an outer housing which terminates in an outer rim; and a preformed facepiece cushion, which is directly or indirectly mounted on the outer housing, the preformed facepiece cushion comprising:
a preformed, soft cushion pad which includes: a proximal end; a distal end; a covering; an interior, which is filled with an upper gel layer and a lower foam layer; a top at the proximal end; a bottom at the proximal end; a pair of sides that extend between the top and the bottom; and a length that is continuous with the pair of sides and extends between the top and the bottom; a top depression which curves downward distally from each side along the length on the top; and a bottom depression which curves downward distally from each side along the length on the bottom;
and a flexible lip which is attached to the covering at the distal end of the preformed, soft cushion pad.

In the acoustic mask, the flexible lip may releasably retain the preformed, soft cushion pad on the outer rim.

In the acoustic mask, the lower foam layer of the preformed, soft cushion pad may have a durometer ranking of 45 to 55 on the Shore OO durometer scale.

In the acoustic mask, the upper gel layer of the preformed, soft cushion pad may weigh 22 grams.

In the acoustic mask, the depressions in the preformed, soft cushion pad may be 10 millimeters deep.

The acoustic mask may further comprise a sleeve which includes a distal end and a proximal end, extends outwardly from the outer rim and is slidably engaged in the outer housing, wherein the flexible lip releasably retains the preformed, soft cushion pad on the proximal end of the sleeve.

In the acoustic mask, the lower foam layer of the preformed, soft cushion pad may have a durometer ranking of 45 to 55 on the Shore OO durometer scale.

In the acoustic mask, the upper gel layer of the preformed, soft cushion pad may weigh 22 grams.

In the acoustic mask, the depressions in the preformed, soft cushion pad may be 10 millimeters deep.

In another embodiment, a method of damping sound with an acoustic mask is provided, the method comprising: a user selecting the acoustic mask described above; the user locating the acoustic mask on their face such that the depression in the top is underneath the user's nose and the depression in the bottom is between the user's lips and chin; and the user speaking into the acoustic mask, thereby damping sound.

The method may further comprise the user selecting a sleeve, sliding the sleeve into the outer housing and releasably attaching the preformed facepiece cushion on the sleeve prior to locating the acoustic mask on their face.

### BRIEF DESCRIPTION OF THE DRAWINGS

FIG. 1 is a schematic of an acoustic mask.

FIG. 2 is a schematic of the preformed facepiece cushion on the sleeve.

FIG. 3 is a schematic of an alternative embodiment acoustic mask.

FIG. 4 is a schematic distal perspective view of the preformed facepiece cushion of the acoustic mask.

FIG. 5 is cross sectional view of the preformed facepiece cushion of the acoustic mask.

### DESCRIPTION

Except as otherwise expressly provided, the following rules of interpretation apply to this specification (written description and claims): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

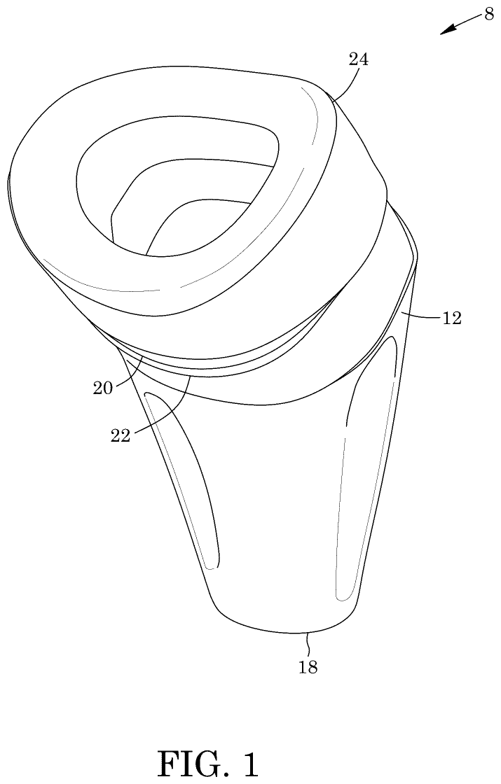

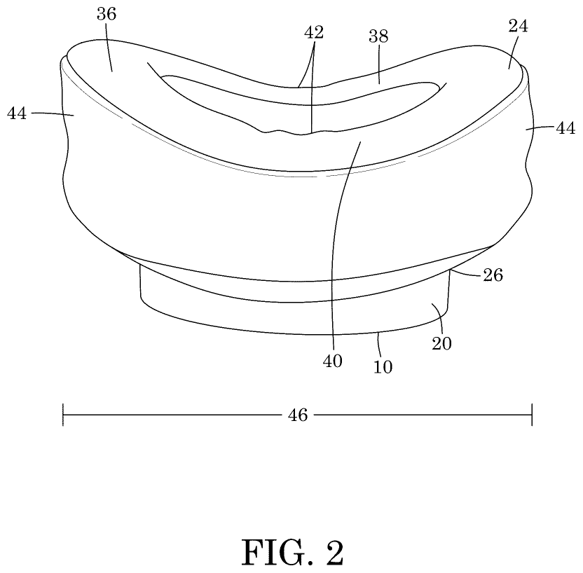

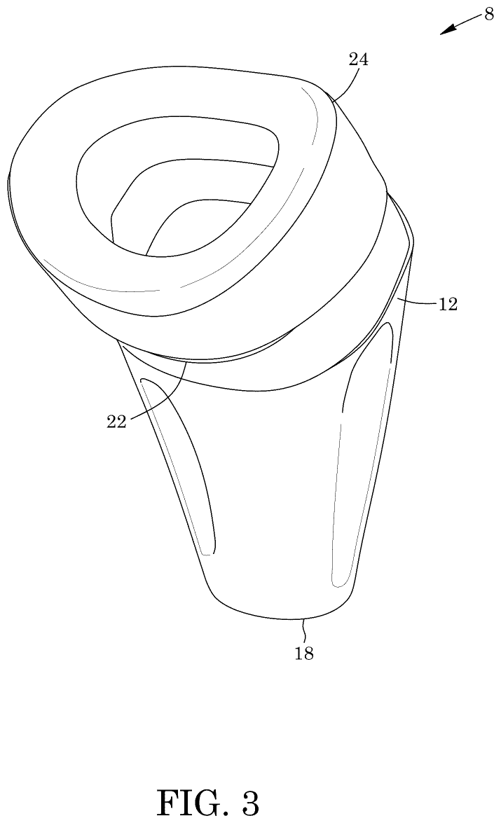

An acoustic mask, generally referred to as 8 is shown in FIG. 1. It includes an outer housing 12 which has an angled, curved back, a generally planar base and two sides extending therebetween to create a wedge shape terminating in a housing distal end 18. A sleeve 20 extends upward from an outer rim 22 and is slidably engaged in the outer housing 12 at a sleeve distal end 10 (see FIG. 2). As shown in FIG. 2, the preformed facepiece cushion 24 is releasably mounted on the proximal end 26 of the sleeve 20. The preformed facepiece cushion 24 can be mounted on many mask types. As shown in FIG. 3, in one embodiment of the acoustic mask 8, the preformed facepiece cushion 24 can be directly mounted on the outer housing 12.

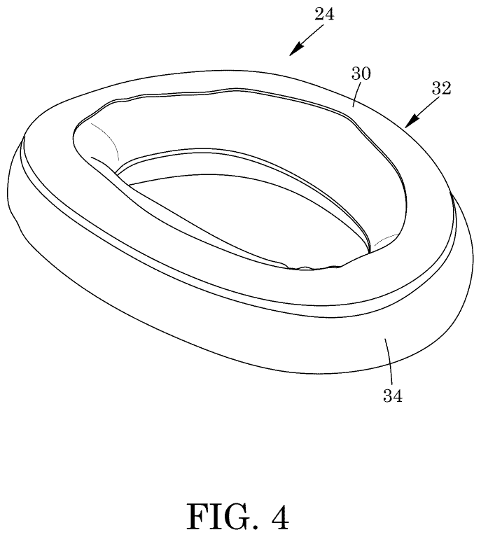

As shown in FIG. 4, the preformed facepiece cushion 24 includes a flexible lip 30 on a distal end, generally referred to as 32, of a preformed soft cushioned pad 34. The flexible lip 30 releasably retains the preformed soft cushion pad 34 either directly or indirectly on the outer housing 12. The preformed soft cushion pad 34 is for locating over a user's mouth, while not interfering with the user's nose or chin. Returning to FIG. 2, at a proximal end 36 of the preformed soft cushioned pad 34, both the top 38 and the bottom 40 have a depression 42 that curves downward from both sides 44 along the length 46.

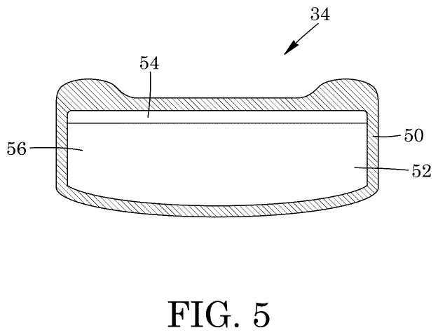

As shown in FIG. 5 the preformed soft cushioned pad 34 includes a covering 50 and an interior 52. As would be known to one skilled in the art, the flexible lip 30 is attached to the covering 50. The interior 52 is filled with an upper gel layer 54 and lower foam layer 56. The foam of the foam layer 56 has a durometer ranking of 50±5 on the Shore OO durometer scale. The gel layer 54 is cooler for the user than is the foam layer 56 and is also more mouldable to slight facial contours. The foam of the foam layer 56 is lighter in weight than the gel, hence the combination allows for the benefits of the gel in a lightweight preformed facepiece cushion 24. There is about 22 grams of gel in each preformed facepiece cushion 24. The preformed facepiece cushion 24 is 35 millimeters tall, 71 millimeters wide, 14 millimeters thick and 96.6 millimeters long. The depressions 42 are 10 millimeters deep at their deepest.

In use, a user attaches the preformed facepiece cushion 24 onto the outer housing 12 either directly or indirectly via the sleeve 20 to provide an acoustic mask 8. The user then locates the preformed facepiece cushion 24 on their face, such that the depression 42 in the top 38 is underneath the user's nose and the depression 42 in the bottom 40 is between the user's lips and chin. The user then speaks into the acoustic mask and the sound emanating from the user is damped.

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize or be able to ascertain using no more than routine experimentation, many equivalents to the specific example embodiments specifically described herein. Such equivalents are intended to be encompassed in the scope of the claims, if appended hereto or subsequently filed.

1. A preformed facepiece cushion for use with an acoustic mask, the preformed facepiece cushion comprising:
a preformed, soft cushion pad which includes: a proximal end; a distal end; a covering; an interior, which is filled with an upper gel layer and a lower foam layer; a top at the proximal end; a bottom at the proximal end; a pair of sides that extend between the top and the bottom; and a length that is continuous with the pair of sides and extends between the top and the bottom; a top depression which curves downward distally from each side along the length on the top; and a bottom depression which curves downward distally from each side along the length on the bottom;
and a flexible lip which is attached to the covering at the distal end of the preformed, soft cushion pad.

2. The preformed facepiece cushion of claim 1, wherein the lower foam layer of the preformed, soft cushion pad has a durometer ranking of 45 to 55 on the Shore OO durometer scale.

3. The preformed facepiece cushion of claim 2, wherein the upper gel layer of the preformed, soft cushion pad weighs 22 grams.

4. The preformed facepiece cushion of claim 3, wherein the top depression and the bottom depression in the preformed, soft cushion pad are 10 millimeters deep.

5. An acoustic mask, the acoustic mask comprising: an outer housing which terminates in an outer rim; and a preformed facepiece cushion, which is directly or indirectly mounted on the outer housing, the preformed facepiece cushion comprising:
a preformed, soft cushion pad which includes: a proximal end; a distal end; a covering; an interior, which is filled with an upper gel layer and a lower foam layer; a top at the proximal end; a bottom at the proximal end; a pair of sides that extend between the top and the bottom; and a length that is continuous with the pair of sides and extends between the top and the bottom; a top depression which curves downward distally from each side along the length on the top; and a bottom depression which curves downward distally from each side along the length on the bottom;
and a flexible lip which is attached to the covering at the distal end of the preformed, soft cushion pad.

6. The acoustic mask of claim 5, wherein the flexible lip releasably retains the preformed, soft cushion pad on the outer rim.

7. The acoustic mask of claim 6, wherein the lower foam layer of the preformed, soft cushion pad has a durometer ranking of 45 to 55 on the Shore OO durometer scale.

8. The acoustic mask of claim 7, wherein the upper gel layer of the preformed, soft cushion pad weighs 22 grams.

9. The acoustic mask of claim 8, wherein the depressions in the preformed, soft cushion pad are 10 millimeters deep.

10. The acoustic mask of claim 5, further comprising a sleeve which includes a distal end and a proximal end, extends outwardly from the outer rim and is slidably engaged in the outer housing, wherein the flexible lip releasably retains the preformed, soft cushion pad on the proximal end of the sleeve.

11. The acoustic mask of claim 10, wherein the lower foam layer of the preformed, soft cushion pad has a durometer ranking of 45 to 55 on the Shore OO durometer scale.

12. The acoustic mask of claim 11, wherein the upper gel layer of the preformed, soft cushion pad weighs 22 grams.

13. The acoustic mask of claim 12, wherein the depressions in the preformed, soft cushion pad are 10 millimeters deep.

14. A method of damping sound with an acoustic mask, the method comprising: a user selecting the acoustic mask of claim 5; the user locating the acoustic mask on their face such that the depression in the top is underneath the user's nose and the depression in the bottom is between the user's lips and chin; and the user speaking into the acoustic mask, thereby damping sound.

15. The method of claim 14, further comprising the user selecting a sleeve, sliding the sleeve into the outer housing and releasably attaching the preformed facepiece cushion on the sleeve prior to locating the acoustic mask on their face.
